(19) United States
(12) Patent Application Publication
(10) Pub. No.: US 2023/0225464 A1
(43) Pub. Date: Jul. 20, 2023

(54) SMART JEWELRY DEVICE AND SOCAIL NETWORK SYSTEM WITH SMART REMINDER AND SOCIAL FUNCTIONALITIES

(71) Applicant: Shengzhe Zhao, Fremont, CA (US)

(72) Inventor: Shengzhe Zhao, Fremont, CA (US)

(21) Appl. No.: 18/152,060

(22) Filed: Jan. 9, 2023

(51) Int. Cl. A44C 5/00; A44C 15/00; H04W 4/80

(52) U.S. Cl. CPC A44C 5/0015; A44C 15/0015; H04W 4/80

(57) ABSTRACT

A smart jewelry device to provide smart reminder and social functionalities is disclosed. This smart jewelry device having embedded SOC chip, illumination units, micro vibration motors can be controlled by mobile devices. This smart jewelry device can be configured to flicker or vibrate following a specific pattern as user defined to reminder user a specific event happened in user's smart terminal device. This smart jewelry device provides a new way of data expression, that is, by encoding the data in including but not limited to Morse code, etc., so that the smart jewelry flashes according to the encoded data, and then the user uses the camera to scan the flashing smart jewelry to decode the data to obtain data, a social network system is built based on this data exchange method that can send or receive some interactive information of friends through the cloud server.

### CROSS-REFERENCE TO RELATED APPLICATIONS

This application claims priority to, and the benefit of, U.S. Provisional Patent Application No. 63/373,118, Entitled “A SMART JEWELRY DEVICE TO PROVIDE SMART REMINDER AND SOCIAL FUNCTIONALITIES”, filed Aug. 22,2022. The content of that application are incorporated by reference in their entirety.

### BACKGROUND OF THE INVENTION

Jewelry refers to the products of gemstones, and precious metals, as well as the jewelry, crafts, and art collection made from these raw materials and semi-finished products. Due to its high collectible and decorative value, it is very popular among fashion people. With the advancement of technology, some jewelries have also incorporated some elements of smart electronic device and become a new type of fashion.

### 1. FIELD OF THE TECHNOLOGY

This technology pertains generally to the wearable smart jewelry device which more particularly focus on providing smart reminder and social functionalities to users.

this smart jewelry device shall have embedded SoC chip, illumination units, sensors, vibration motor and micro motors inside.

the illumination units shall illuminate inside jewelry with different color at different parts by using the way of transmission or refraction to exhibit the beauty of the inner color and texture of gemstone.

the embedded SoC chip shall connect with user's smart terminal device (cellphone, iPad, PC etc.), the smart terminal device will monitor the important events happening in device and control the illumination units, vibration units or movable parts of smart jewelry to illuminate or vibrate or rotate some parts following a specific pattern which is the combination of flashing, vibrating and moving to provide smart reminder of important events to user.

user's smart terminal device can login to remote cloud sever to connect with user's friends so that some interactions between friends such as notification, message, media, interactive games, other data can be delivered to user's smart jewelry device or exchanged through user's smart jewelry device thus forming a social networking platform.

### 2. DISCUSSION

Existing smart jewelry devices have several deficiencies:

[1]. Compared to traditional jewelry devices, current smart jewelry devices focus more on functionality and are not decorative items, and cannot highlight the material and craftsmanship of the gemstones themselves. They lack decorative value compared to decorative items.

[2]. Current smart jewelry devices do not provide smart reminders or provide not-smart-enough reminder.

[3]. Some current smart jewelry devices can also emit light or flash, but do not provide an encoding scheme to specify the meaning of this light emission or flashing, do not provide a method to utilize the flashing of light to deliver data.

[4]. Current smart jewelry does not provide users with rich interactive features with friends.

The smart jewelry device disclosed in this patent will feature on using transparent or semi-transparent materials including gemstone, crystal, man-made glass as main body material, using illumination units to exhibit the beauty of transparent gemstone. This smart jewelry device can be configured to flash or vibrate as user defined to reminder user a specific event happened in user's smart terminal device (cellphone, iPad, PC). This smart jewelry device can send or received some interactions including message, media, emoji, other data to/from friends through could server.

The present invention provides a novel smart jewelry device, the important feature of which is that the main body and decorative parts are made of transparent or translucent jewelry materials, the embedded control chip controls the illumination unit, and the illumination unit is controlled by an application program to display the inner color and texture of the transparent gemstone. beauty. Compared with traditional jewelry, this smart jewelry can show the inner color and texture of gemstones more beautifully.

The embedded SoC chip can also control the micro motor to control the movement of some decorative parts, which can provide more fun for jewelry.

The current smart devices usually use the method of long-pressing a button or a touch sensor to switch on and off, but this method does not provide the user with the feedback of the current booting progress. When the user presses the button for a long time, it is not known whether the power on/off process has started, to what progress, or whether it is because the contact problem has not actually started. The present invention provides a new way, that is, using a color-changing light to indicate the progress of turning on or turning off the device, and this way can give the user an intuitive indication to allow the user to switch on and off the machine more conveniently.

This smart jewelry device declares a dynamic configuration method to configure the controllable units in the device. Different smart jewelry devices and different firmware versions may have different configurations for the control unit. These configuration tables will be saved on the remote cloud server. When users use different smart jewelry devices or upgrade to different firmware versions, they can always get the correct configuration from the remote server.

The present invention provides a smart reminder method, namely, monitoring events in user terminal device, defining different blinking patterns for different events, and identifying different events through different blinking patterns. The present invention also defines two different types of flickering modes, that is, a time-limited flashing mode and an infinite flashing mode. The present invention also claims a method for specifying the arrangement order of the blinking patterns in a list to form more complex blinking patterns. This invention also states that the blinking pattern can have multiple keywords, which can be used to filter application notifications and provide special blinking patterns for specific events to better alert users.

The present invention constructs a social network platform jointly by smart jewelry, user's smart terminal device, application programs running on the terminal device and multiple remote cloud servers. By registering personal information of users, jewelry device information is sent to the cloud server and shared with friends, users can play interactive games, send interactive messages, media files, emoticons, control commands and other data to each other.

The embedded SoC chip can control the flashing of the illumination unit or control the vibration of the micro vibration motor, control the length of the flash or flash different colors through the encoding scheme, or control the length of the vibration of the vibration motor to express the encoded data, and recognize the flashing light through the camera of the terminal device The data is thus decoded, giving a clear meaning to the flickering of the illumination unit or the vibration of the vibrating unit. Based on this method, there is a new way of transmitting data between users, or between users' terminal devices and smart jewelry. Some existing smart jewelry devices can also emit light or flash, but do not provide an encoding scheme to specify the meaning of the light or flash, which is the biggest difference between the present invention and previous inventions. In this way, the present invention achieves the following innovations:

[1]. Messages can be sent between users remotely, and the smart jewelry can express the content of the message by controlling the flashing or vibration through the encoding scheme.

the terminal device can decode the message by scanning the flashing lights of the jewelry through the camera.

[2]. Media files or emojis can be sent between users remotely, and the smart jewelry can express the content of the media by controlling the flashing or vibration through the encoding scheme. the terminal device can decode the media or emoji by scanning the flashing lights of the jewelry through the camera.

[3]. Users can send control commands or other data remotely, smart jewelry controls flickering or vibration through encoding schemes, and the terminal device can understand the meaning of the data by scanning the flashing lights of the jewelry through the camera.

[4]. A new transmission method for binding passwords is provided. The existing QR code solutions generally provide additional paper printed with the QR code, and the cards or stickers are easily lost. In this method, the password is provided by the jewelry itself, and a binding mode is specially provided to help the user retrieve the password, so it is safer and more convenient.

[5]. The existing works can only add users through smart terminal devices, and cannot add users through smart jewelry devices. This invention provides a new way of adding users by scanning smart jewelry with the camera of smart terminal device.

[6]. When smart jewelry users meet face to face, this invention provides a new way of using the camera of smart terminal device to scan smart jewelry to exchange data with each other.

The present invention provides a way of using smart jewelry to play games, that is, users can play interactive games with friends through networking, or play games by themselves, and the illumination units or vibration units of smart jewelry act as an effect element in the game to provide more fun for the game.

The present invention provides a way of using smart jewelry as auxiliary props in the game system, that is, users can use cameras to scan each other's smart jewelry to collect virtual game points, and the internal algorithm will calculate the points based on the difference of the user's personal attributes. Collected game points can be used to purchase in-game virtual items and upgrades game levels. Different game levels can have different levels of smart jewelry to reflect the user's honor and achievements in the game.

### BRIEF DESCRIPTION OF DRAWINGS

FIG. 1: is a front detail view of a composite smart jewelry device.

FIG. 2: is an elevational view, indicated by line 3-3 of FIG. 2, of the composite device of FIG. 1.

FIG. 3: is another front detail view, showing a separated embodiment of the invention.

FIG. 4: is a side elevational view indicated by line 5-5 of FIG. 3, of the separated components of FIG. 3.

FIG. 5: is an alternate embodiment of a special shape smart jewelry device.

FIG. 6: is a process diagram of encoding and decoding blinky message.

FIG. 7: is a schematic diagram of a smart jewelry device providing smart reminder & social functionalities.

### ITEMIZED PARTS LIST

10: is the overall social network system with the smart jewelry device, terminal devices,
cloud servers to provide smart reminder & social functionalities.
12: are the cloud servers.
14: are the smart terminal devices (Phone, tablet, PC).
16: are the smart jewelry devices.
16A: is a composite smart jewelry device.
18: is the main body of jewelry device 16A.
20: is decoration Part A of jewelry device 16A.
22: is decoration Part B of jewelry device 16A.
24: is the main light LED or called A light.
26: is the background light LED or called B light.
28: is the color changing light LED or called C light.
29. Is the touch sensor.
30: is the SOC chip.
32: is the vibration motor.
34: is the charging circuit.
36: is the battery.
38: is the separated embodiment of the jewelry device.
40: is the main body of jewelry device 38.
42: is the decoration Part A of the separated embodiment of the jewelry device.
44: is the decoration Part B of the separated embodiment of the jewelry device.
46: is the special shape embodiment of the jewelry device.
48: is the main body of the special shape embodiment of the jewelry device.

### DETAILED DESCRIPTION OF THE INVENTION

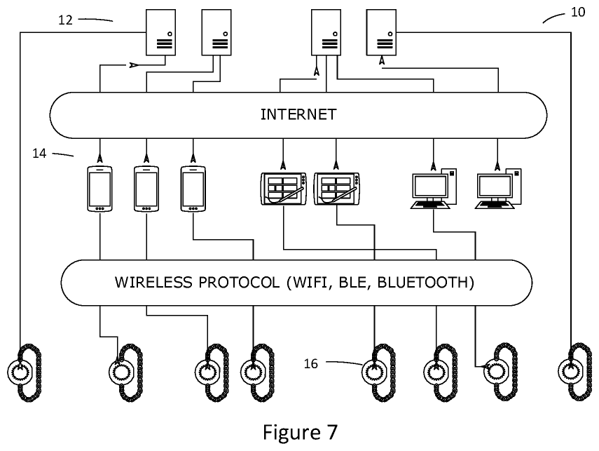

The entire system shall include the smart jewelry device, user's smart terminal device, a software application running in the terminal device, multiple remote servers running in cloud. Refer to FIG. 7 for System Architecture

The smart jewelry device 16 will connect to user's terminal device 14 through wireless communication protocol including but not limited to Bluetooth, BLE, WIFI. The software application running in terminal device shall be responsible for managing smart jewelry device 16, the software application shall also register current user and user's smart jewelry devices to remote cloud server 12. User can search friends from cloud server 12 and add friends into friend list in software application. After getting granted permission, User can know what devices his/her friends have and being used, User and his friends can send each other messages, media files, emoji to smart jewelry, or play interactive games through smart jewelry, thus forming a social networking platform.

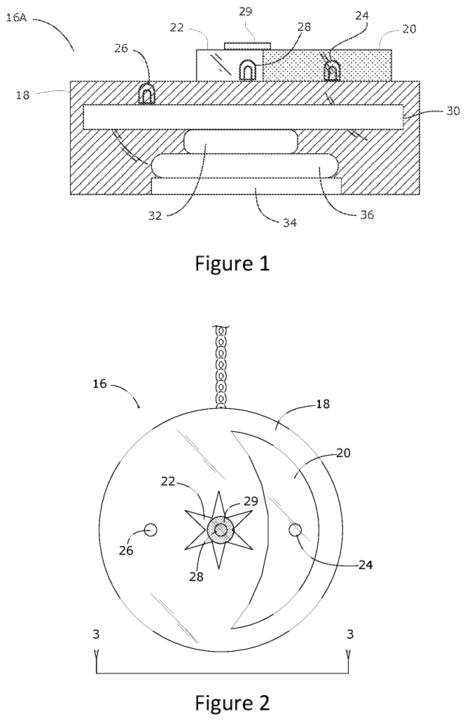

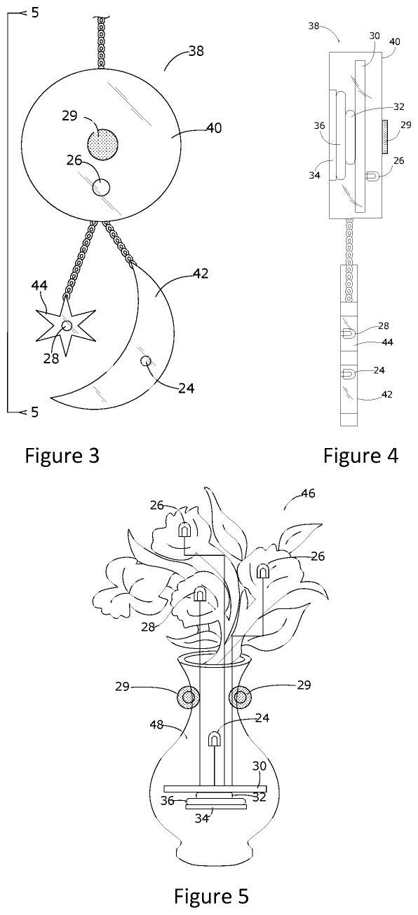

As shown in FIG. 1, a smart jewelry device includes: a jewelry body 18 and one or multiple jewelry decoration parts 20,22 fixedly connected to its upper facet. The jewelry body 18 is mainly made of transparent or semi-transparent materials, including but not limited to gemstone, opalite, jade, crystal, and glass. The jewelry body 18 is built with a control chip 30, a micro vibration motor 32, a battery 36 and a charging module 34, and the lower end of the SoC chip (30) is provided with a micro vibration motor 32, The lower end of the vibration motor 32 is provided with a battery 36, the connection between the SoC chip 30 and the vibration motor 32 and the battery 36 is an electrical connection, and the battery 36 is connected with a charging module 34, and the charging module 34 extends to the lower end of the main body 18. There may be multiple jewelry decoration parts 20,22, which are external decorations formed by inlaying, connecting or splicing gemstones carved into special shapes and precious metals. The jewelry decoration part 20,22 has the built-in illumination units 24,26,28. In order to reduce the overall size of the jewelry, the jewelry main body 18 can be separated from multiple jewelry decoration parts 20,22 as shown in FIG. 3, FIG. 4. The jewelry main body 18 and the jewelry decoration part 20,22 have shapes such as pendants, vases, animals or daily objects as shown in FIG. 5.

The main body 18 of this smart jewelry device 16A could be cylinder shape or special carved shape to express the design of smart jewelry. (Refer to FIG. 2, FIG. 3, FIG. 4, FIG. 5). Main body 18 shall be hollow to accommodate SoC chip 30, battery 36, charging circuit 34, vibration motor 32 (if it is supported). Multiple illumination units 24,26,28 and sensors or micro motor 32 will be deployed in main body or decoration parts. The illumination unit is used to illuminate gemstone in order to exhibit the beauty of gemstone. The sensor is used to receive some input event and the micro motor is used to create some kind of motion of decoration part. The SoC chip 30 is placed above the micro vibration motor 32, and the SoC controller 30 should support multiple GPIO pins, and the GPIO pins should be connected to controllable units, such as illumination units 24,26,28, micro-motors or micro vibration motors 32 to drive these units or connect to the sensor to receive data, the SoC controller 30 can have pins that support interface protocols such as SPI, 12C, etc. These protocols will be used to connect hardware that requires such an interface, and the SoC chip 30 is equipped with a wireless communication module, support Bluetooth, BLE, WIFI communication protocols, and can communicate with the user's smart terminal device 14 (mobile phone, iPad, PC).

The smart jewelry device shall have at least 3 illumination units in logic 24,26,28. one is Main Light which is called A Light 24. one is Background Light which is called B Light 26, the third one is Color-changing Light which is called C Light 28. More illumination units are optional.

This smart jewelry device shall use a new way which uses a color-changing light to indicate the progress of turning on process to turn on device. long pressing 3 seconds on touch sensor 29 shall turn on device. The touching shall turn on the C Light 28 firstly. If user solidly pressed 3 seconds on the touch sensor 29, C light 28 shall change color gradually starting from Red to Green. Green color is the good sign for user to know 3s have passed, then device shall be turned on. if there is contact problem between user's finger and touch sensor 29, C Light 28 shall change back to beginning color Red, that is the sign to tell user to solidly press on sensor to try again.

Similar as the turn on process, after turn on device, long pressing 5 seconds on touch sensor 29 to turn off device. The C Light 28 shall be used as an indicator for the progress of turn off process. C light 28 shall change color gradually starting from Red to deep green then blue. The color deep green or blue is the good sign for user to know 5s have passed, then device shall be turned off.

This smart jewelry device can provide smart reminder functionality. The smart jewelry device 16 shall monitor the notifications happening in user's terminal device 14 and then send reminder to user to notify user what important events are happening. The blinky pattern will be used as reminder. The blinky pattern shall define the blinky devices used in this pattern, blinky times, blink cycle time. For example, a blinky pattern named TripleAB-SingleV could blink A Light and B light 3 times with cycle time 1s and vibrate the vibration motor one time.

There are 2 kinds of blinky patterns, one is limited time blinky pattern, other one is infinite blinky pattern. The limited time blinky pattern for example, TripleAB shall blink A Light and B Light 3 times then stop automatically. The infinite blinky pattern will blink forever once it is triggered by a specific event, it won't stop blinking until the user removes the notification in terminal device.

The smart jewelry device 16 can be configured to monitor multiple application notifications in user's terminal device 14. Each application notification can have multiple blinky patterns in a list with specified sequence to form more complicated pattern. For example, a list with the pattern sequence DoubleAB-SingleC-DoubeAB, the smart jewelry will blink LightAB twice then Light C once then LightAB twice again. Such specific blinky pattern corresponding to a specific application notification will works as the reminder for user to be aware of that application notification. For example, blink A Light 3 times to indicate receiving email event, vibrate infinitely to indicate incoming phone call.

Each blinky pattern can have multiple keywords which is showing in application notification to filter out specific notification. For example, when receive the phone call from friend Tom, the phone call notification will have word “Tom” in notification subject. User can define a blinky pattern for phone app with keyword “Tom”, then smart jewelry will only blink when receive the phone call from Tom.

The smart jewelry 16 provides a new data transmission method between the user's terminal device 14 and the smart jewelry 16, and assigns a definite meaning to the flashing or glowing of the jewelry. It is characterized in that the jewelry built-in control chip 30 controls the flashing of the illumination unit 24 or controls the vibration of the micro vibration motor 32, and controls the length of the flashing or flashing different colors by including but not limited to Morse code or data bitmap coding schemes, or control the vibration length of the vibration motor 32 to express the encoded data, and the user's application software recognizes the flashing lights through the camera of the terminal device to decode the data to obtain the data.

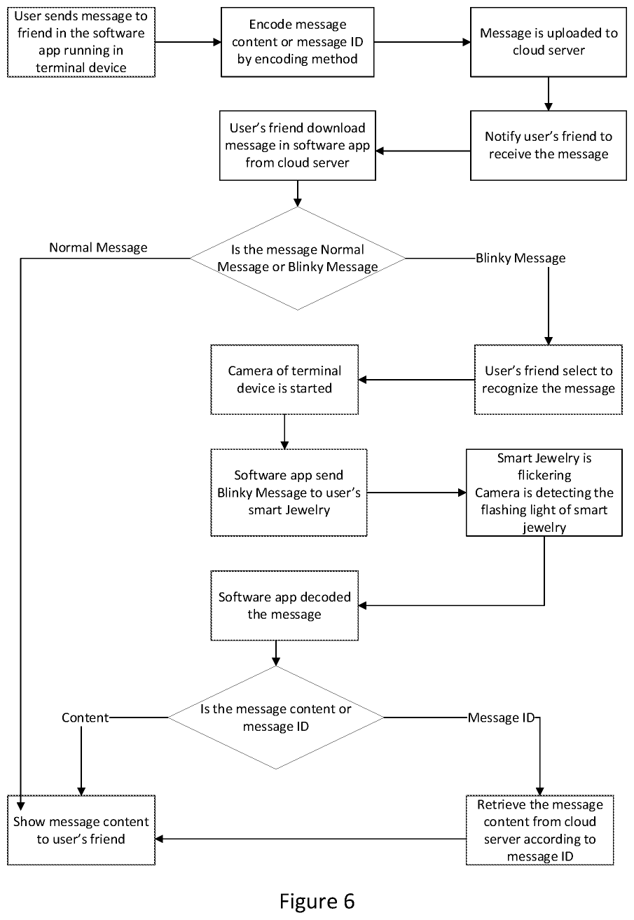

Based on the above data transfer method, the user's jewelry device 16 can also transmit the following types of data between its own application software or other users' application software: text messages, media files, emoticons, control commands and data, user ID, user characteristic data, etc. such message transferred between user and his/her friend is called as Blinky Message in software app. The entire process is explained in FIG. 6.

For example, when a user sends data to a friend through a cloud server, the software application running on the user's terminal device receives the data and sends it to the smart jewelry device. The light of the jewelry device, decodes the data, and then displays the decoded data to the user or executes the corresponding command. When the user sends a text message “SOS” to a friend, the Morse code of “SOS” is “. . . --- . . . ”, 3 short signals are S, 3 long signals are O. and the A light of the smart jewelry will flash long 3 times then short blink 3 times then long blink 3 times. The application of the terminal device will turn on the camera to monitor the light signal of the smart jewelry. If it detects 3 short flashes, it will be decoded as S, and if it detects 3 long flashes, it will be decoded as O.

When the user sends binary data such as 0×15 to a friend, the binary representation of 0×15 is 0001 0101, if we use long flashes to represent 1, and short flashes to represent 0, the smart jewelry will short flash 3 times and long flash once (indicating 0001) and then short Flash 1 time, long flash 1 time, short flash 1 time, long flash 1 time (indicates 0101). If we use light A to represent 1 and light B to represent 0, the smart jewelry will flash in the order of BBBA BABA.

Based on the above data transmission method, a password transmission method for binding devices is provided. For security reasons, only the device owner is allowed to communicate with the smart jewelry device through the secure channel between the smart jewelry device and the terminal device. This requires a binding process. After the user turns on the device, the software application will remind the user to add this new smart jewelry device so that the software application can manage it. When the user presses the “+” button in the software to add a device, this triggers the binding process, which requires a password, which is defined in the firmware of the smart jewelry device. The current popular method is to use QR codes to transmit passwords. The smart device purchased by the user will be randomly attached with a QR code, or a QR code will be generated on the terminal device, and the user scans the QR code with the camera of the smart device to get password. A new way can be used here to obtain the password defined in the firmware. At this stage of the binding process, the smart jewelry device will display the password by flashing the A light. The password is encoded by encoding methods including but not limited to Morse code or other encoding methods. Light A flashes according to the encoded data. Turn on the camera of the user terminal device to scan the Morse code to decode the password, and then use this password to connect the smart jewelry device with the user's End device binding.

This smart jewelry device 16 also supports a password retrieval mode for users to retrieve the password used for binding. When the device is turned off, press and hold the touch sensor for 3 seconds to turn it on, and continuously press and hold the sensor for 5 seconds to enter the password retrieval mode. In the password retrieval mode, the smart jewelry device will flash the password according to the encoding protocol such as Morse code. The user can scan again with the camera of the terminal device 14 to get the password.

Furthermore, based on the above jewelry device and data transmission method, a social network system 10 is constructed, including the above-mentioned smart jewelry device 16, as well as user terminal devices 14, dedicated software applications running on the user's smart terminal devices 14, and multiple cloud servers 12. The smart jewelry device 16 is connected to the user terminal device 14 or cloud server 12 through a wireless communication protocol, and the user terminal device 14 is connected to the cloud server 12 through a mobile communication network or the Internet. The software application should register the current user and the user's smart jewelry device 16 to the remote cloud server 12. Users can search for friends through the cloud server 12, and add friends to the friend list in the software application. After obtaining the permission, the user can know what devices friends have and what devices they are using. The user and his friends can send text messages, media files, emoticons to each other to smart jewelry, or play interactive games through smart jewelry.

Based on this network system 10, this smart jewelry device 16 shall use a dynamic configuration method for configuring the controllable units in device. Remote cloud server 12 shall define a configuration table for device configurations. The smart jewelry device 16 will connect to remove server 12 to search the corresponding configuration which matches with its device name and firmware version then use the configuration to configure those controllable units. The device configuration table shall define the unit name (for example, Front Main Light, Vibration Motor), unit control name (for example, Light A), unit states (ON, OFF), unit control code (This is the command issued by software app in terminal device to control the units in smart jewelry device), unit control sequence, and also other attributes (such as unit color etc.). when the smart jewelry device turns on, it shall search latest configuration in remote could server, compare it with the one currently being used in local and if find newer one, shall download it and use it.

Users can play interactive game through smart jewelry device by utilizing controllable units of smart jewelry. One example is the matching pair game. Players are given a 20×20 grid, each block has a hidden color. User and his/her friend shall flip the blocks in turn to see what color is for that block. The color of block shall be displayed by Light of smart jewelry device. User and his/her friend shall remember the color then try to find a pair of blocks that have same color. Whoever find more matched pairs will win the game. Another example is using the jewelry's light and vibration as accompaniment for music.

Currently a popular way to represent user's ID in software application is using a QR code. With this smart jewelry device, a novel way which is called Blinky Code can be used to represent user's ID that is when meet friend in person, the user's ID shall be encoded by an encoding method including but not limited to Morse code, then the encoded ID shall be sent to smart jewelry device, smart jewelry device shall blink according to the encoded codes, user uses camera to scan friend's blinky smart jewelry to get friend's ID then add it to friend list.

When the users of smart jewelry meet in person, they can use the camera of terminal device to scan the smart jewelry each other to exchange data. Firstly, they will exchange user ID, according to the user ID, they can get more personal data from cloud server, those personal data will be normalized to express a quantitative indicator of a personal attribute. This way shall be used for gaming system for users to earn award points. Users meet friends every day to collect smart jewelry lights to earn award points. The algorithm will calculate the point based on the difference of personal attributes such as the difference of age, the difference of geographical location, the difference of gender, the difference of personalities, The bigger the difference, the higher the points. then user can use the points to buy outfits, equipment, instruments, props and to upgrade levels in games. Different gaming levels have their corresponding smart jewelries to reflect user's honor in game just like Medal of Honor used in reality.

1. A smart jewelry device, characterized by comprising: a jewelry body 18 and one or multiple jewelry decoration parts 20,22 fixedly connected to its upper facet. The jewelry body 18 is mainly made of transparent or semi-transparent materials, including but not limited to gemstone, opalite, jade, crystal, and glass. The jewelry body 18 is built with a control chip 30, a micro vibration motor 32, a battery 36 and a charging module 34, and the lower end of the SoC chip 30 is provided with a micro vibration motor 32, The lower end of the vibration motor 32 is provided with a battery 36, the connection between the SoC chip 30 and the vibration motor 32 and the battery 36 is an electrical connection, and the battery (The lower end of 36) is connected with a charging module 34, and the charging module 34 extends to the lower end of the main body 18. There may be multiple jewelry decoration parts (for example, 20,22), which are external decorations formed by inlaying, connecting or splicing gemstones carved into special shapes and precious metals. The jewelry decoration part 20,22 has the built-in illumination units 24,26,28. In order to reduce the overall size, the jewelry main body 18 can be separated from multiple jewelry decoration parts 20,22. The jewelry main body 18 and the jewelry decoration part 20,22 have shapes such as pendants, vases, animals or daily objects.

2. A kind of smart jewelry device according to claim 1, is characterized in that, comprises SoC chip 30, illumination units 24,26,28, sensors 29, micro vibration motor 32 and micro-motor. The illumination units have at least three units 24,26,28, which are respectively the main light or A light 24, the background light or B light 26, and the color-changing light or C light 28. The SoC chip 30 is placed above the micro vibration motor 32, and the SoC controller 30 should support multiple GPIO pins, and the GPIO pins should be connected to controllable units, such as illumination units, micro-motors or micro vibration motors to drive these units or connect to the sensor to receive data, the SoC controller 30 can have pins that support interface protocols such as SPI, 12C, etc. These protocols will be used to connect hardware that requires such an interface, and the SoC chip 30 is equipped with a wireless communication module, support Bluetooth, BLE, WIFI communication means, and can communicate with the user's smart terminal device 14 (mobile phone, iPad, PC).

3. The smart jewelry device according to claim 2, characterized in that it adopts an interactive method to turn on or turn off device, that is, when the user presses the touch sensor for a long time, the color change of the color-changing light (C light) 28 is used to indicate the progress of turning on or turning off the device.

4. The smart jewelry according to claim 2, characterized in that it provides the user with a smart reminder function, that is, the application software installed on the user's smart terminal device 14 can monitor the events in the user's terminal device 14, for different Events define different flashing patterns, and the application software can control the smart jewelry 16 to flash or vibrate according to different flashing patterns to mark different events. There are two different types of flashing modes namely time-limited flashing mode and infinite flashing mode. Flashing patterns can be combined to form more complex flashing patterns. The flashing mode has multiple keywords, which can filter application notifications and provide special flashing modes for specific events to provide users with smart reminders.

5. A new data transmission method between the user's terminal device and the smart jewelry. This method specifies a clear meaning for the flashing or glowing of the jewelry. It is characterized in that the jewelry built-in control chip 30 controls the flashing of the illumination unit 24,26,28 or controls the vibration of the micro-vibration motor 32, and controls the length of the flashing or flashing different colors by including but not limited to Morse code or data bitmap coding schemes, or control the vibration length of the vibration motor to express the encoded data, and the user's application software recognizes the flashing lights through the camera of the terminal device 14 to decode the data to obtain the original data. Based on this data transmission method, the user's jewelry device can transmit the following types of data between its own application software or other user's application software: text messages, media files, emoticons, control commands and data, binding passwords, user IDs, user characteristic data, etc.

6. According the data transmission method of claim 5, a password transmission method for binding devices is provided, which is characterized in that when a user device is bound, the jewelry device expresses the encoded data of the binding password through the flicker of the illumination unit and the user's application starts the camera to identify the flashing light to obtain the password to bind the device.

7. A social network system comprising the smart jewelry device as described in claim 2, characterized in that it further includes the user terminal device, the dedicated software application running on the terminal device, and multiple cloud servers. The smart jewelry device is connected to the user terminal device or the cloud servers through a wireless communication protocol, and the user terminal device is connected to the cloud servers through a mobile communication network or the Internet.

8. A social network system according to claim 7, characterized in that it further includes a firmware upgrade module which defines a device configuration table through a remote cloud server. The smart jewelry device searches for the corresponding configuration that matches its device name and firmware version when it is connected to the cloud server, and then uses the configuration to configure the controllable units in the system. The device configuration table defines unit names, unit control names, unit states, unit control codes, unit control orders, and other attributes. When the smart jewelry device is turned on, it searches for the latest configuration in the remote server based on the device configuration table and compares it with the currently used configuration, if a newer configuration is found, it is downloaded and used.

9. A social network system according to claim 7, characterized in that it has social attributes, through which users register personal information, jewelry device information to the cloud server and share with friends, and users can send data to each other's jewelry devices. Data between users and friends is sent through the network to the user's application software, and the data is expressed to the user through the flashing of the jewelry after being encoded, including but not limited to Morse code or a data bitmap. The user uses the terminal device's camera to decode the data to obtain the original data. Based on the obtained data, users can play interactive games, send interactive messages, media files, emoticons, control commands, and other data.

10. A social network system according to claim 7, characterized in that the user encodes the user ID in an encoding method including but not limited to Morse code, and then sends the encoded ID to the smart jewelry device. The smart jewelry device flashes according to the encoded code, and the user uses the camera to scan the flashing smart jewelry of their friend to obtain the friend's ID and then add it to the friend list. When the users of the smart jewelry meet each other, they can scan each other's smart jewelry through the camera on their terminal device for user ID exchange, then according to the user ID to get more personal data. This method will be used in the game system for users to earn bonus points. Users meet friends every day, collect smart jewelry lights, and earn reward points. The algorithm calculates points based on differences in personal attributes such as age difference, geographical location difference, gender difference, and personality difference between the user and their friends. The greater the difference, the higher the points. Then use the points to buy clothing, equipment, instruments, props, and upgrade game levels. Different game levels have corresponding smart jewels, which reflect the user's honor in the game just like the medal of honor used in reality.
